(19) United States
(12) Patent Application Publication
(10) Pub. No.: US 2009/0238077 A1
(43) Pub. Date: Sep. 24, 2009

(54) METHOD AND APPARATUS FOR PROVIDING AUTOMATED PROCESSING OF A VIRTUAL CONNECTION ALARM

(76) Inventors: Paritosh Bajpay, Edison, NJ (US); Mojgan Dardashti, Holmdel, NJ (US); Zhiqiang Qian, Holmdel, NJ (US); Michael John Zinnikas, North Brunswick, NJ (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/051,624

(22) Filed: Mar. 19, 2008

(51) Int. Cl. G06F 11/00

(52) U.S. Cl. 370/241

(57) ABSTRACT

A method and apparatus for providing automated processing of a virtual connection alarm on a packet network, e.g., a Virtual Private Network (VPN), are disclosed. For example, the method receives an alarm related to at least one virtual connection for a virtual private network (VPN) from a provider edge (PE) router, and determines whether the VPN has reached a first threshold for a maximum number of virtual connections or a second threshold for a pre-determined percentage of the maximum number of virtual connections. The method generates a new ticket or updating an existing ticket in response to the alarm if either the first threshold or the second threshold is reached.

The present invention relates generally to communication networks and, more particularly, to a method and apparatus for providing automated processing of virtual connection alarms on a packet network, e.g., a Virtual Private Network (VPN).

### BACKGROUND OF THE INVENTION

An enterprise customer may build a Virtual Private Network (VPN) by connecting multiple sites or users over a network from a network service provider. When service failure or degradation occurs, it may be detected by the network service provider or reported by a customer to the network service provider. For example, if a virtual connection for a customer fails, the customer may report the failure to the network service provider. The network service provider may then dispatch maintenance personnel to perform trouble isolation and repair. However, in a large network, the cost of dispatching personnel for each detected and/or reported problem is cost prohibitive. In addition, the customer may be receiving a degraded service or no service at all while alarms are being generated. The degraded service and the delay in performing maintenance affect customer satisfaction.

### SUMMARY OF THE INVENTION

In one embodiment, the present invention discloses a method and apparatus for providing automatic processing of virtual connection alarms on a packet network, e.g., a Virtual Private Network (VPN). For example, the method receives an alarm related to at least one virtual connection for a virtual private network (VPN) from a provider edge (PE) router, and determines whether the VPN has reached a first threshold for a maximum number of virtual connections or a second threshold for a pre-determined percentage of the maximum number of virtual connections. The method generates a new ticket or updating an existing ticket in response to the alarm if either the first threshold or the second threshold is reached.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network with automated processing of a virtual connection alarm;

FIG. 3 illustrates a flowchart of a method for providing automated processing of a virtual connection alarm; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing automated processing of a virtual connection alarm on a packet network, e.g., a Virtual Private Network (VPN). Although the present invention is discussed below in the context of virtual private networks, the present invention is not so limited. Namely, the present invention can be applied for other networks that support services that have a threshold for a maximum number of allowed connections.

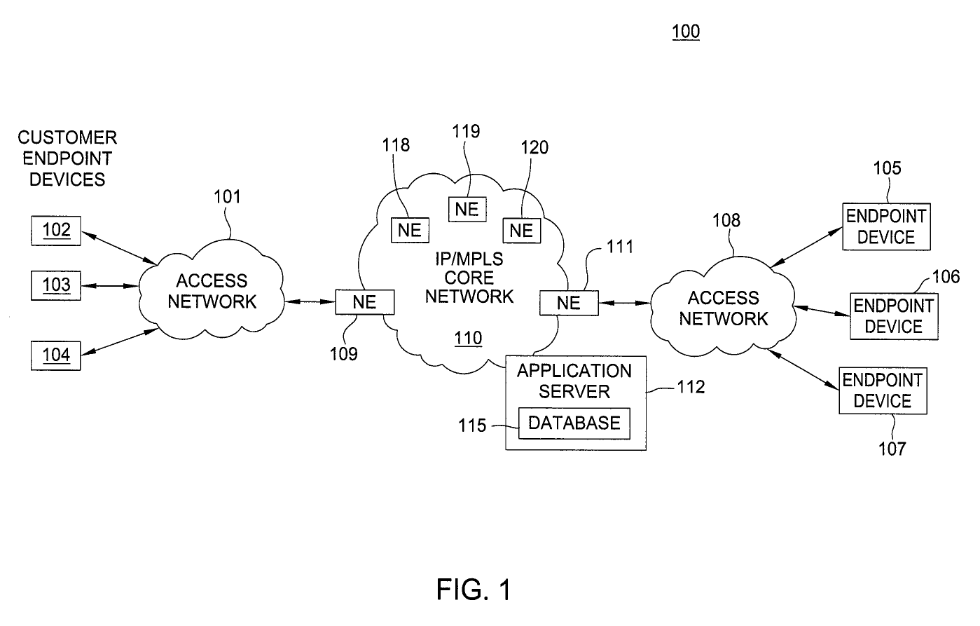

FIG. 1 is a block diagram depicting an exemplary packet network 100 related to the current invention. Exemplary packet networks include Internet protocol (IP) networks, Ethernet networks, and the like. An IP network is broadly defined as a network that uses Internet Protocol such as IPv4 or IPv6 and the like to exchange data packets.

In one embodiment, the packet network may comprise a plurality of endpoint devices 102-104 configured for communication with the core packet network 110 (e.g., an IP based core backbone network supported by a service provider) via an access network 101. Similarly, a plurality of endpoint devices 105-107 are configured for communication with the core packet network 110 via an access network 108. The network elements 109 and 111 may serve as gateway servers or edge routers for the network 110.

The endpoint devices 102-107 may comprise customer endpoint devices such as personal computers, laptop computers, Personal Digital Assistants (PDAs), servers, routers, and the like. The access networks 101 and 108 serve as a means to establish a connection between the endpoint devices 102-107 and the NEs 109 and 111 of the IP/MPLS core network 110. The access networks 101 and 108 may each comprise a Digital Subscriber Line (DSL) network, a broadband cable access network, a Local Area Network (LAN), a Wireless Access Network (WAN), a 3^{rd} party network, and the like. The access networks 101 and 108 may be either directly connected to NEs 109 and 111 of the IP/MPLS core network 110, or indirectly through another network.

Some NEs (e.g., NEs 109 and 111) reside at the edge of the core infrastructure and interface with customer endpoints over various types of access networks. An NE that resides at the edge of a core infrastructure is typically implemented as an edge router, a media gateway, a border element, a firewall, a switch, and the like. An NE may also reside within the network (e.g., NEs 118-120) and may be used as a mail server, honeypot, a router, or like device. The IP/MPLS core network 110 also comprises an application server 112 that contains a database 115. The application server 112 may comprise any server or computer that is well known in the art, and the database 115 may be any type of electronic collection of data that is also well known in the art. Those skilled in the art will realize that although only six endpoint devices, two access networks, five network elements, one application server, and so on are depicted in FIG. 1, the communication system 100 may be expanded by including additional endpoint devices, access networks, network elements, application severs, etc. without altering the present invention.

The above IP network is described only to provide an illustrative environment in which packets for voice and data services are transmitted on networks. An enterprise customer may build a Virtual Private Network (VPN) by connecting multiple sites or users over a network from a network service provider. When a network service is either degraded or failed, the service trouble may be detected by the network service provider or reported by a customer to the network service provider. For example, a customer may report a trouble for a virtual connection to the network service provider. The network service provider may then dispatch maintenance personnel to perform trouble isolation and repair. However, in a large network, the cost of dispatching personnel for each detected and/or reported problem is cost prohibitive. In addition, the customer may be receiving a degraded service or no service at all while alarms are being collected and analyzed for trouble isolation and the proper work center is being notified to make the necessary repairs.

In one embodiment, the present invention discloses a method and apparatus for providing automatic processing of virtual connection alarms on a packet network, e.g., a Virtual Private Network (VPN). In order to clearly describe the current invention, the following networking terminologies and concepts are first provided:
A Virtual Private Network (VPN); and
A VPN Routing and Forwarding (VRF) table.

A Virtual Private Network (VPN) refers to a network in which a set of customer locations communicate over a network service provider's network or the Internet in a private manner. The set of customer locations that may communicate with each other over the VPN are configured when the VPN is setup.

A VPN Routing and Forwarding (VRF) table is an instance of a routing table in a PE, populated with routes for a specific VPN. A PE may have multiple routing tables with one VRF for each VPN.

To illustrate, for each VPN, a VRF table is instantiated on each PE providing connection for a CE. For example, in one embodiment, if a customer has three (3) CE locations connected to three (3) different PE locations, each of the three PEs is populated with routes for the VPN containing the three CE locations.

When a customer subscribes to a VPN service, the service provider and/or the customer will determine the number of connections to be allowed for the VPN. For example, a large enterprise customer may request a service with a maximum of a 1000 virtual connections, while a small enterprise customer may request a service with a maximum of 50 virtual connections. The service provider may then configure the VPN allowing the applicable maximum number of virtual connections. The PE routers with the VRF tables may then keep track of the number of virtual connections and deny connection requests that are in excess of the allowed number of virtual connections. For example, if 1000 virtual connections are allowed, then the 1001^{st} connection request will be denied by the PE router. The denied request may cause the customer to report a connection trouble to the service provider. However, since the trouble is not related to a network outage or a maintenance event, a proper diagnosis of the reported problem may take several hours to arrive at the conclusion that the customer has exceeded the maximum allowed number of virtual connections. To address this criticality, the current invention provides an automatic processing of a virtual connection alarm such that a timely trouble isolation is performed.

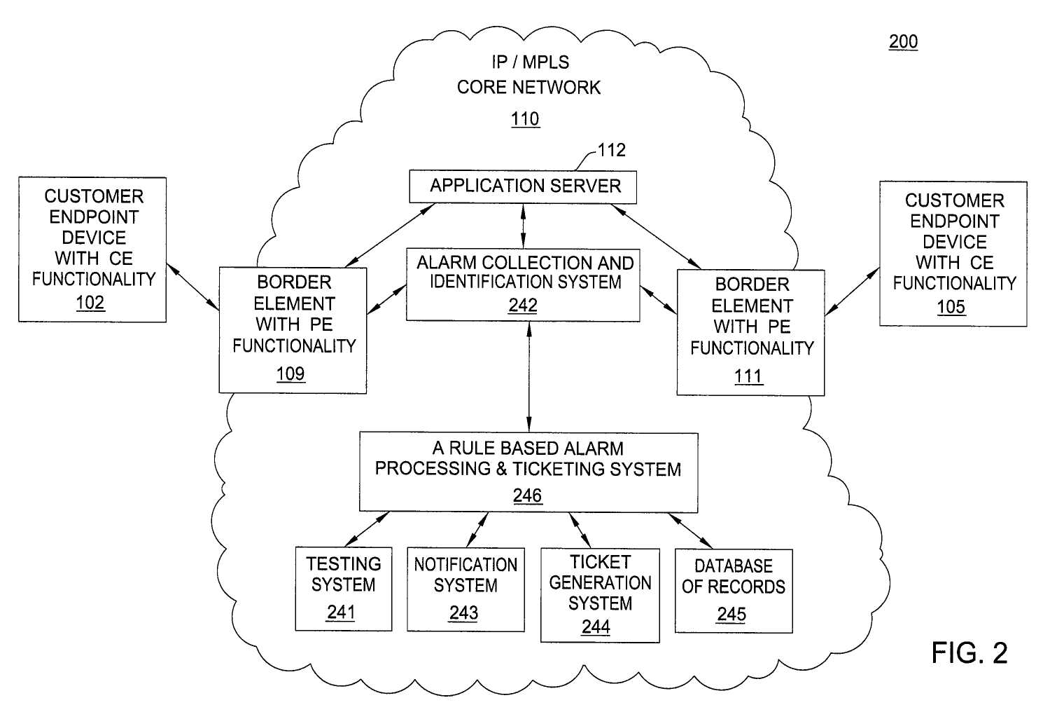

FIG. 2 illustrates an illustrative network 200 with automated processing of a virtual connection alarm of the present invention. For example, customer endpoint devices 102 and 105 function as CE routers for a VPN connecting two customer locations over an IP/MPLS core network 110. The IP/MPLS core network 110 comprises an application server 112, border elements 109 and 111, a testing system 241, an alarm collection and identification system 242, a notification system 243, a ticket generation system 244, a database of record 245, and a rule based alarm processing and ticketing system 246.

Border elements 109 and 111 function as PE routers for the IP/MPLS core network 110. The rule based alarm processing and ticketing system 246 is connected to the various systems 241-245 for automating processing of network alarms. The application server 112 enables customers to subscribe to services with automated processing of network alarms.

The testing system 241 is used for sending test packets and receiving responses. For example, the testing system 241 may send various test signals, e.g., ping signals to ports on switches, to obtain snapshots of various counters in routers and switches, and so on. The ticket generation system 244 is accessible by customers and service provider personnel. For example, a customer or work center personnel may interact with an Interactive Voice Response (IVR) system and generate a ticket. The ticket may also be created from automatically detected alarms by the alarm collection and identification system 242. In one embodiment, the alarm collection and identification system 242 is connected to the PE routers 109 and 111. Similarly, the notification system 243 may be used to provide notifications to a customer, or one or more work centers, e.g., status notifications, alarm notifications, resolution of a ticket notifications and the like.

In one embodiment, the customer endpoint device with CE router functionality 102 is connected to the border element with PE router functionality 109. The customer endpoint device with CE router functionality 105 is connected to the border element with PE router functionality 111. Traffic from CE router 102 travels towards CE router 105 via PE router 109, IP/MPLS core network 110 and PE router 111. Traffic from CE router 105 travels towards CE router 102 via PE router 111, IP/MPLS core network 110 and PE router 109.

In one embodiment, the current invention provides automatic processing of alarms for a virtual connection by first gathering alarms related to a number of virtual connections for a VPN from the PE routers. In one example, the alarm collection and identification system 242 gathers alarms from PE routers 109 and 111, for a VPN exceeding the maximum number of virtual connections. In another example, an alarm may be received for exceeding a pre-determined percentage, e.g., 70%, of the maximum number of virtual connections for a VPN. The alarm collection and identification system 242 may then forward the alarms gathered from the PE routers to the rule based alarm processing and ticketing system 246.

The rule based alarm processing and ticketing system 246 may then correlate the alarm with circuit data. For the example above, the rule based alarm processing and ticketing system 246 may access a database of record 245, and retrieves a circuit identification, a port identification, a switch identification or a router identification, service options, etc. The rule based alarm processing and ticketing system 246 may use the circuit data to retrieve a more detailed throughput information from the router/switch for the VPN.

For the example above, where the received alarm is for a VPN exceeding the maximum number of virtual connections, the circuit data may be used to take two snapshots of register values in the router and then to determine traffic throughput. For example, by taking a snapshot of ingress and egress packet counters, waiting a predetermined time (e.g., 30 seconds), taking another snapshot of the same packet counters, the method may determine whether or not any packets are being sent and received. If the two snapshots of the ingress packet counters are identical, then no packet is being received and the trouble may be related to a Layer 1 or Layer 2 network. If the two snapshots of the egress packet counters are identical, then no packet is being sent and the trouble may be related to a Layer 1 or Layer 2 network. If the two snapshots of the ingress and egress packet counters indicate that traffic is still being received and sent, then the method may create a ticket for the alarm and notify a work center indicating that the VPN has exceeded the maximum number of virtual connections. The work center may in turn notify the enterprise customer, upgrade service level (e.g., increase the maximum number of allowed virtual connections), and so on in accordance with the service agreement for the customer. For example, a customer may prefer to be notified before a change is made to the customer's service level. However, another customer may prefer to have the service automatically upgraded as soon as possible and to be billed for the upgraded service, thereby minimizing the number of denied virtual connection requests.

Alternatively, for the example above, where the received alarm is for a VPN reaching 70% of the maximum number of virtual connections, the circuit data may be used to take two snapshots of the register values in the router and then verify usage level. A work center and/or the customer may then be notified of usage level, i.e. reaching 70% of the maximum number of virtual connections. This approach allows the work center to be notified well before the maximum number of virtual connections limit is reached.

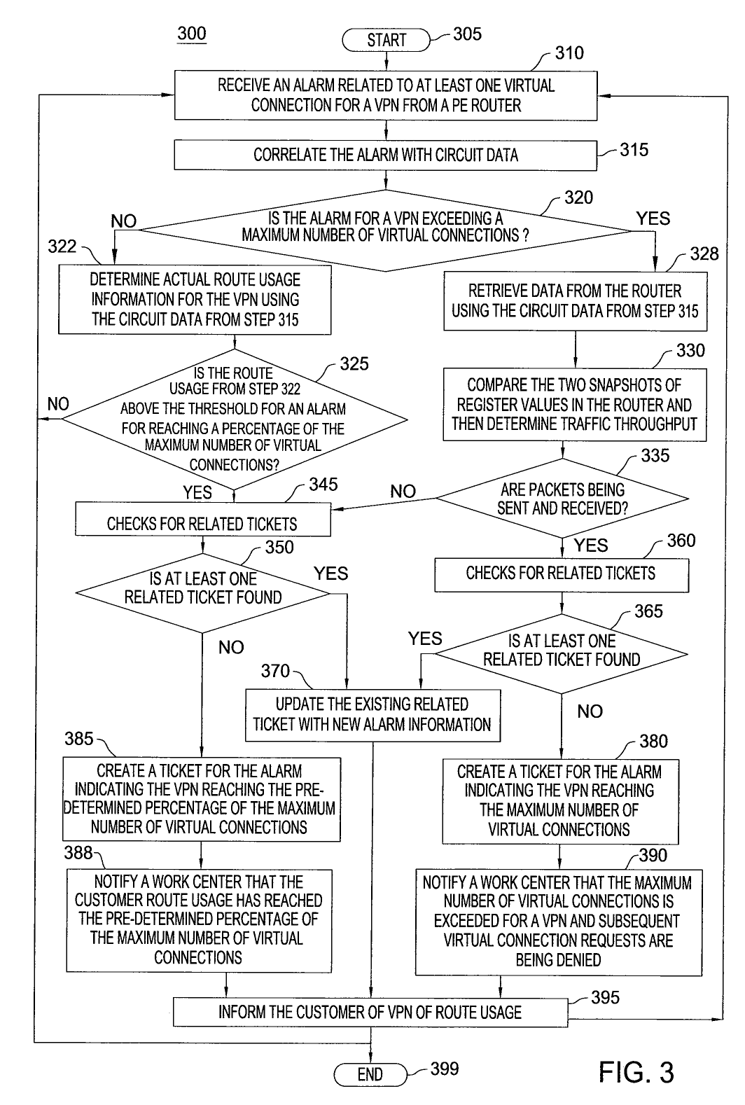

FIG. 3 illustrates a flowchart of a method 300 for providing automatic processing of a virtual connection alarm. For example, method 300 can be implemented by the rule based alarm processing and ticketing system 246. Method 300 starts in step 305 and proceeds to step 310.

In step 310, method 300 receives an alarm related to at least one virtual connection for a VPN from a PE router. For example, a rule based alarm processing and ticketing system receives an alarm for a VPN exceeding a maximum number of virtual connections, or an alarm for a VPN exceeding a pre-determined percentage (e.g., 70%) of a maximum number of virtual connections.

In step 315, method 300 correlates the alarm with circuit data. For example, the rule based alarm processing and ticketing system may access a database of record, and retrieves circuit identification, port identification, switch identification or router identification, service options, etc.

In step 320, method 300 determines whether or not the alarm is for a VPN reaching or exceeding a maximum number of virtual connections. For example, the alarm may be for exceeding the maximum number of virtual connections where connection requests are being denied, or the alarm may simply be for reaching a predetermined percentage of the maximum number where connections have not yet been denied. If the alarm is for exceeding a maximum number of virtual connections, the method proceeds to step 328. Otherwise, the method proceeds to step 322.

In step 322, method 300 determines actual route usage information for the VPN using the circuit data from step 315. In one embodiment, the method may obtain multiple snapshots of the register values in the router, determine usage, and then determine whether or not the VPN has reached the predetermined threshold for an alarm for reaching a percentage of the maximum number of virtual connections. For example, the alarm may be for reaching 70% of the maximum number of virtual connections. It should be noted that the predetermined threshold can be selected in accordance with the requirements of a particular implementation, and the 70% as used in the present disclosure should not be interpreted as a limitation of the present invention. The method then proceeds to step 325.

In step 325, method 300 determines whether or not the usage from step 322 is above the threshold for an alarm for reaching or exceeding a percentage of the maximum number of virtual connections. If it is above the threshold, then the method proceeds to step 345. Otherwise, the method returns to step 310 to continue receiving alarms.

In step 328, method 300 retrieves data from the router using the circuit data from step 315. For the example above, where the received alarm is for a VPN exceeding the maximum number of virtual connections, the circuit data may be used to obtain two snapshots of register values in the router.

In step 330, method 300 compares the two snapshots of the register values in the router and then determines the traffic throughput. For example, by taking a snapshot of the ingress and egress packet counters, waiting a predetermined time (e.g. 30 seconds), taking another snapshot of the same packet counters, the method may determine whether or not packets are being sent and/or received. The method then proceeds to step 335.

In step 335, method 300 determines whether or not packets are being sent and/or received. For example, if the two snapshots of the ingress packet counters are identical, then no packet is being received. Similarly, if the two snapshots of the egress packet counters are identical, then no packet is being sent. If packets are still being sent and received, then the method proceeds to step 360. Otherwise, the method proceeds to step 345.

In step 345, method 300 checks for related tickets. For example, a customer or a work center personnel may have interacted with an IVR system and may have generated a ticket for a Layer 1 or layer 2 trouble for the same circuit. The method then proceeds to step 350.

In step 350, method 300 determines whether or not at least one related ticket is found. For example, a Layer 1 or Layer 2 ticket related to the current trouble may be found. If a related ticket is found, then the method proceeds to step 370. Otherwise, the method proceeds to step 385.

In step 360, method 300 checks for related tickets. For example, a customer or a work center personnel may have interacted with an IVR system and may have generated a ticket for a virtual connection problem for the same circuit.

In step 365, method 300 determines whether or not at least one related ticket is found. If a related ticket is found, then the method proceeds to step 370. Otherwise, the method proceeds to step 380.

In step 370, method 300 updates the existing related ticket with new alarm information. For example, if a Layer 1 or Layer 2 related trouble ticket is found, then the current alarm may be related to the previously reported trouble. Hence, the method adds the newly reported alarm to the existing ticket. The method then proceeds to step 395.

In step 380, method 300 creates a ticket for the alarm. For example, the method creates a ticket indicating the maximum number of virtual connections is exceeded for a VPN. The method then proceeds to step 390.

In step 385, method 300 creates a ticket for the alarm indicating the VPN reaching the pre-determined percentage of the maximum number of virtual connections. The method then proceeds to step 388.

In step 388, method 300 notifies a work center that the customer route usage has reached the predetermined percentage of the maximum number of virtual connections. The method then proceeds to step 395.

In step 390, method 300 notifies a work center that the maximum number of virtual connections is exceeded for a VPN and subsequent virtual connection requests are being denied. The method then proceeds to step 395.

In step 395, method 300 informs the customer of VPN of route usage. The method then ends in step 399 or returns to step 310 to continue receiving new alarms.

It should be noted that although not specifically specified, one or more steps of method 300 may include a storing, displaying and/or outputting step as required for a particular application. In other words, any data, records, fields, and/or intermediate results discussed in the method 300 can be stored, displayed and/or outputted to another device as required for a particular application. Furthermore, steps or blocks in FIG. 3 that recite a determining operation, or involve a decision, do not necessarily require that both branches of the determining operation be practiced. In other words, one of the branches of the determining operation can be deemed as an optional step.

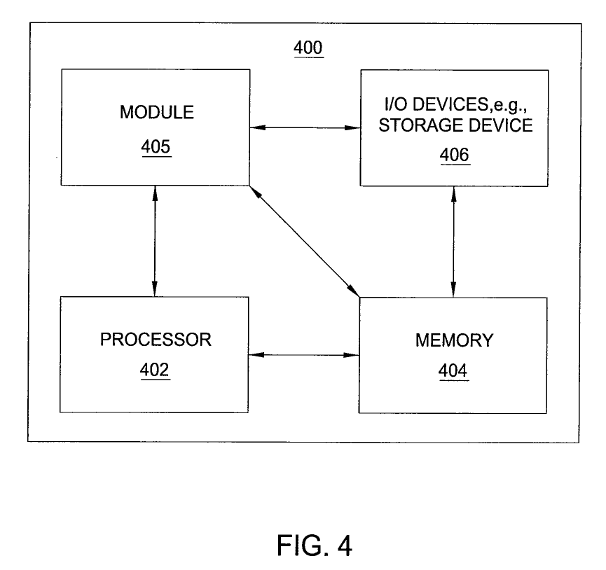

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for providing automatic processing of a virtual connection alarm, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 405 for providing automatic processing of a virtual connection alarm can be loaded into memory 404 and executed by processor 402 to implement the functions as discussed above. As such, the present method 405 for providing automatic processing of a virtual connection alarm (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for processing an alarm, comprising:
receiving an alarm related to at least one virtual connection for a virtual private network (VPN) from a provider edge (PE) router;
determining whether said VPN has reached a first threshold for a maximum number of virtual connections or a second threshold for a pre-determined percentage of said maximum number of virtual connections; and
generating a new ticket or updating an existing ticket in response to said alarm if either said first threshold or said second threshold is reached.

2. The method of claim 1, wherein said determining whether said VPN has reached said first threshold for said maximum number of virtual connections or said second threshold for said pre-determined percentage of said maximum number of virtual connections, comprises:
correlating said alarm with circuit data; and
determining actual route usage information for said VPN using said circuit data.

3. The method of claim 2, wherein said circuit data comprises an identification of at least one of: a circuit, a port, a switch or a router.

4. The method of claim 2, wherein said determining said actual route usage information, comprises:
obtaining a first snapshot of one or more register values in a router;
waiting a time interval;
obtaining a second snapshot of said one or more register values in said router; and
determining an actual route usage by comparing said first and second snapshots of said one or more register values in said router for said time interval.

5. The method of claim 1, further comprising:
notifying a work center that said VPN has reached said pre-determined percentage of said maximum number of virtual connections if said second threshold is reached.

6. The method of claim 1, further comprising:
notifying a work center that said VPN has reached said maximum number of virtual connections if said first threshold is reached.

7. The method of claim 4, further comprising:
informing said customer of said actual route usage of said VPN.

8. A computer-readable medium having stored thereon a plurality of instructions, the plurality of instructions including instructions which, when executed by a processor, cause the processor to perform the steps of a method for processing an alarm, comprising:
receiving an alarm related to at least one virtual connection for a virtual private network (VPN) from a provider edge (PE) router;
determining whether said VPN has reached a first threshold for a maximum number of virtual connections or a second threshold for a pre-determined percentage of said maximum number of virtual connections; and
generating a new ticket or updating an existing ticket in response to said alarm if either said first threshold or said second threshold is reached.

9. The computer-readable medium of claim 8, wherein said determining whether said VPN has reached said first threshold for said maximum number of virtual connections or said second threshold for said pre-determined percentage of said maximum number of virtual connections, comprises:
correlating said alarm with circuit data; and
determining actual route usage information for said VPN using said circuit data.

10. The computer-readable medium of claim 9, wherein said circuit data comprises an identification of at least one of: a circuit, a port, a switch or a router.

11. The computer-readable medium of claim 9, wherein said determining said actual route usage information, comprises:
obtaining a first snapshot of one or more register values in a router;
waiting a time interval;
obtaining a second snapshot of said one or more register values in said router; and
determining an actual route usage by comparing said first and second snapshots of said one or more register values in said router for said time interval.

12. The computer-readable medium of claim 8, further comprising:
notifying a work center that said VPN has reached said pre-determined percentage of said maximum number of virtual connections if said second threshold is reached.

13. The computer-readable medium of claim 8, further comprising:
notifying a work center that said VPN has reached said maximum number of virtual connections if said first threshold is reached.

14. The computer-readable medium of claim 11, further comprising:
informing said customer of said actual route usage of said VPN.

15. An apparatus for processing an alarm, comprising:
means for receiving an alarm related to at least one virtual connection for a virtual private network (VPN) from a provider edge (PE) router;
means for determining whether said VPN has reached a first threshold for a maximum number of virtual connections or a second threshold for a pre-determined percentage of said maximum number of virtual connections; and
means for generating a new ticket or updating an existing ticket in response to said alarm if either said first threshold or said second threshold is reached.

16. The apparatus of claim 15, wherein said determining means, comprises:
means for correlating said alarm with circuit data; and
means for determining actual route usage information for said VPN using said circuit data.

17. The apparatus of claim 16, wherein said circuit data comprises an identification of at least one of: a circuit, a port, a switch or a router.

18. The apparatus of claim 16, wherein said means for determining said actual route usage information, comprises:
means for obtaining a first snapshot of one or more register values in a router;
means for waiting a time interval;
means for obtaining a second snapshot of said one or more register values in said router; and
means for determining an actual route usage by comparing said first and second snapshots of said one or more register values in said router for said time interval.

19. The apparatus of claim 15, further comprising:
means for notifying a work center that said VPN has reached said pre-determined percentage of said maximum number of virtual connections if said second threshold is reached, or for notifying a work center that said VPN has reached said maximum number of virtual connections if said first threshold is reached.

20. The apparatus of claim 18, further comprising:
means for informing said customer of said actual route usage of said VPN.
